(19) United States
(12) Patent Application Publication
(10) Pub. No.: US 2007/0145852 A1
(43) Pub. Date: Jun. 28, 2007

(54) Stator of an electric motor

(75) Inventors: Wolfgang Schon, Langenargen (DE); Karl-Hermann Ketteler, Markdorf (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 11/638,901

(22) Filed: Dec. 14, 2006

(30) Foreign Application Priority Data
Dec. 15, 2005 (DE) 102005059846.3

(51) Int. Cl. H02K 1/00; H02K 21/00; H02K 3/04; H02K 19/26

(52) U.S. Cl. 310/180; 310/208; 310/207; 310/201

(57) ABSTRACT

A stator for an electric motor consisting at least of a stator core (1) with grooves (2) and splines (3) and with a winding which, in turn, consists of a plurality of part-windings. The part-windings are fitted in the grooves (2) and each part-winding consists of a plurality of first and second coil groups (6, 7) having different shapes. For a part-winding, the first coil group (6) is connected in alternation to a second coil group (7) by way of their electric connection ends (16).

This application claims priority from German Application Serial No. 10 2005 059 846.3 filed Dec. 15, 2005.

### FIELD OF THE INVENTION

The invention concerns a stator of an electric motor.

### BACKGROUND OF THE INVENTION

From DE 10 2004 001 842 A1, a stator with a stator core is known, which has a plurality of grooves and splines. A winding, consisting of several coils, is fitted into the grooves. To make this possible, the coils are pre-wound in such a manner that they can pass over the splines without problems, while the grooves have parallel sides and the splines widen out at their free ends. One or more coils are arranged in each groove.

From DE 103 08 893 A1, a stator with a stator core is known, in which a plurality of coils are arranged in each groove. The ends of the coils project in the axial direction far beyond the stator core and cross-over one another there.

In the known stators, the coils are arranged in the grooves in such a manner that in the radial and axial direction there are intermediate spaces between them. This allows cooling. The intermediate spaces between the coils, on the one hand, increase the bulk of the stator and, on the other hand, reduce the fullness of the stator grooves. Reduction of the fullness decreases the power density of the machine.

The purpose of the present invention is to provide a stator with a very compact structure, which takes up only little axial and radial space.

### SUMMARY OF THE INVENTION

According to the invention, the stator consists of a stator core with grooves and splines. Into the grooves fits a winding which, in turn, consists of a plurality of part-windings. The part-windings consist of a plurality of coil groups, which are magnetically equivalent, but have different shapes. A part-winding is formed of a first coil group with a first shape and a second coil group with a second shape, in alternation.

The first coil group is shaped such that the winding heads are at an angle. As its two axial ends. There, it is bent in such a manner that, when fitted into the grooves of the shaped stator core, it extends radially outward. At its winding heads, the first coil group is shaped to match the shape of the stator core, where it extends parallel to the axial end faces of the stator core. The winding heads of the first coil group are shaped to fit around the stator core very snugly, so that their projection distance advantageously corresponds only to the necessary bend radius of the coil group.

In one design, the stator core is slightly recessed in its transition zone from the grooves to the axial end face of the stator core, and is thereby adapted to the bend radius of the coil group. This allows the coil group to fit particularly snugly against the stator core.

The second coil group is only angled at a first winding head. There, it is bent in such a manner that, when fitted in the stator core, it extends radially inward. Its second winding head projects in the axial direction beyond the stator core and beyond the winding heads of the first coil group. At its first winding head, the second coil group is bent so as to extend parallel to a surface of the rotor. Usually, at that end of the rotor, there is a rotor bar whose shape and position depend on the size of a short-circuit ring.

A part-winding for a phase of the electric motor now consists of a plurality of coil groups connected to one another by their electric contact ends. The first and second coil groups consist of one or more coils. In one design, each coil group consists of just one coil. This makes the radial extension of the stator very small. In one design, the coils are also wound from insulated flat wire. In this case, the width of the flat wire corresponds to the width of the groove and the grooves are parallel-sided. This enables the maximum possible groove filling, giving a high power density. Because of the advantageous shaping of the coils at their winding heads, the axial extension of the stator is also small. Owing to their compact shape, the coils are also very simple to make by mechanized means.

### BRIEF DESCRIPTION OF THE DRAWINGS

The invention will now be described, by way of example, with reference to the accompanying drawings in which:

FIG. 1 is a view of the stator core;

FIG. 2 is a structure of a first coil group;

FIG. 3 is a structure of a second coil group;

FIG. 4 is a partial view of the stator, and

FIG. 5 is a partial view of the stator and the rotor.

### DETAILED DESCRIPTION OF THE INVENTION

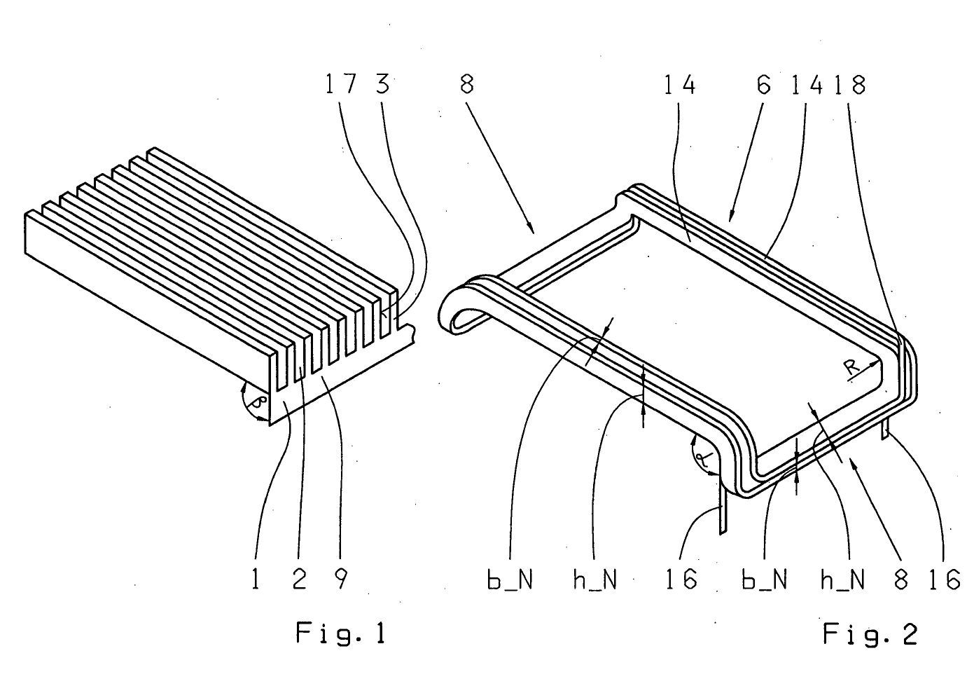

FIG. 1 shows a view of a stator core 1 with grooves 2 and splines 3. Sides 17 of the grooves 2 are parallel over their entire length. The transition between the grooves 2 and an axial end face 9 of the stator core 1 is rectangular in this case. In another design version that edge is rounded.

In a different design, at their transition to the end face 9 of the stator core 1, the grooves 2 are recessed and adapted to the bend radius of coil groups 14, 22. This enables the coils 14, 22 to fit in closer contact with the stator core 1. Once coil groups 6, 7 have been fitted in, the stator core 1 is shaped so as to form the cylindrical stator core 1.

FIG. 2 shows the first coil group 6. This first coil group 6 has two coils 14 parallel to one another and connected by a transition 18. At their winding heads 8, the coils 14 are angled through 90°. The bend radius r can also be seen through which the winding heads 8 have to be deformed. In addition, a height h_N and a width b_N of the coil 14 are shown. The height h_N and the width b_N are chosen such that the coil 14 can be fitted accurately into the groove 2. The first coil group 6 is connected by its connection ends 16 with further coil groups 6, 7 to form a part-winding.

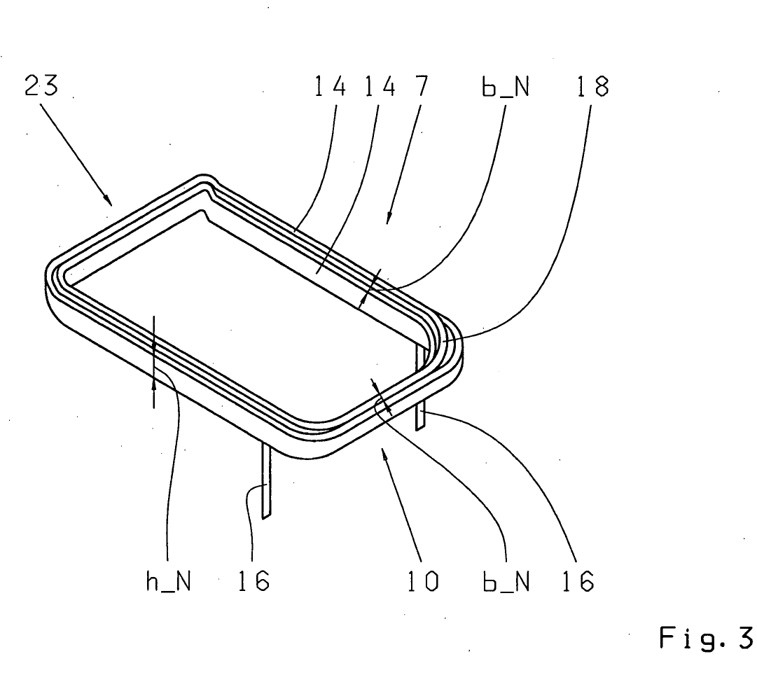

FIG. 3 shows the second coil group 7. This second coil group 7 is only angled at its second winding head 23. A first winding head 10 of the second coil group 7 is shaped to extend parallel to the rotor bar (11) of the rotor 12. The angle y through which it is angled depends on the shape of a rotor 12. The second coil group 7 also consists of two parallel coils 22 connected to one another by the transition 18. The height h_N and the width b_N of a coil are again shown. Here too, the height h_N and the width b_N are chosen such that the coil 22 can be fitted accurately into the groove 2. Like the first coil group 6, so also the second coil group 7 is connected by connection ends 16 to other coil groups 6, 7 to form a part-winding.

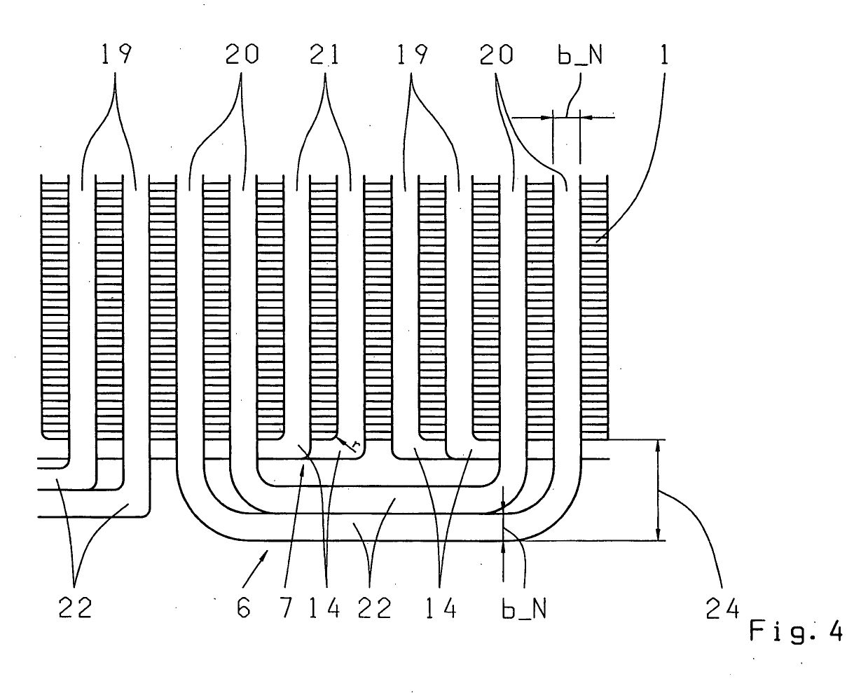

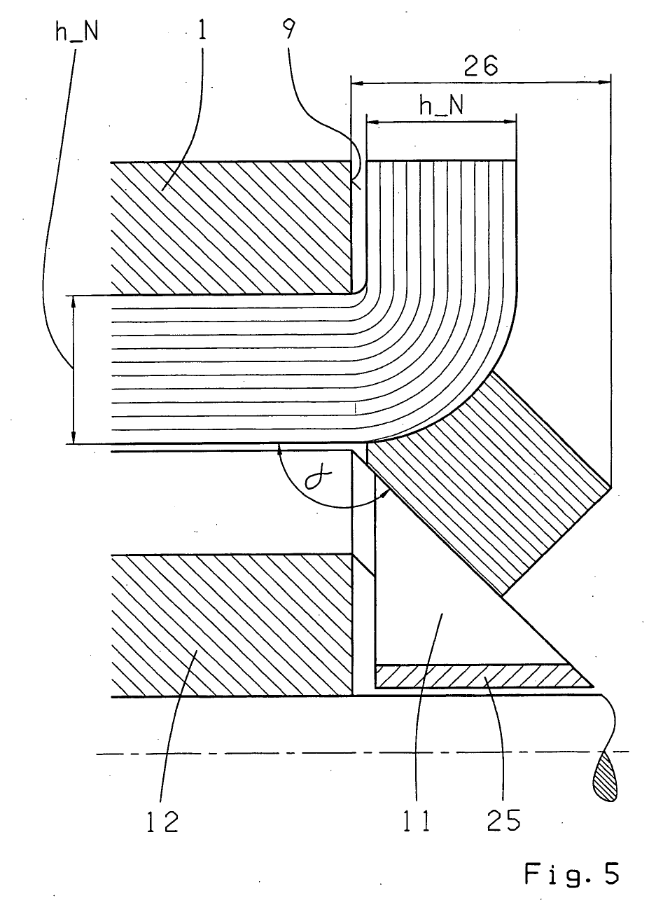

FIG. 4 shows a stator core 1 in which different coils 14, 22 are arranged. The electric motor has three phases 19, 20, 21. These are represented at the top of FIG. 4. It can be seen that respective first 19, second 20 and third 21 phases alternate in the circumferential direction. In this, each phase consists of the first and second coil groups 6, 7, in each case with two coils 14, 22. Although the first and second coil groups 6, 7 have different shapes, they have the same magnetic properties. The width b_N of a groove and an overhang 24 of the winding as a whole on this side is determined by the height of each groove h_, the bend radius r and twice the groove width b_N. If the coil groups 6, 7 have more than two coils 14, 22, the overhang 24 increases correspondingly.

FIG. 5 shows the second axial end of the stator (not shown in FIG. 4). There, the second coil group 7 is bent radially inward. The angle y through which the second coil group 7 is bent inward depends on the shape of a rotor bar 11, which is, in turn, influenced by the position and size of a short-circuit ring 25 of the rotor 12. The bending of the second coil group 7 radially inward saves more axial space. Thereby, the overhang 24 of the winding can, in this case, reach about 1.5 times the height h_N. The shape of the second coil group 7 defines the assembly direction of the rotor 12.

### REFERENCE NUMERALS

1 stator core
2 groove
3 spline
6 first coil group
7 second coil group
8 winding head of the first coil group
9 axial end face of the stator core
10 first winding head of the second coil group
11 rotor bar
12 rotor
14 coil
16 connection ends
17 sides of the groove
18 transition between coils
19 first phase
20 second phase
21 third phase
22 coil
23 second winding head of the second coil group
24 axial overhang
25 short-circuit ring of the rotor
y angle at the winding head of the second coil group
h_N groove height
b_N groove width
r bend radius

1-8. (canceled)

9. A stator for an electric motor, the stator comprising:
a stator core (1) with grooves (2) and splines (3) and a plurality of part-windings, which comprise a first coil group (6) and a second coil group (7), the first and the second coil groups (6, 7) are fitted into the grooves (2) of the stator core (1), the first coil group (6) has a shape and the second coil group (7) has a shape which is different from the shape of the first coil group (6), and the first coil group (6) is connected to the second coil group (7), in alternation, to form a part-winding.

10. The stator according to claim 9, wherein the first coil group (6) has a shape such that when the first coil group (6) is fitted in the grooves (2) of the stator core (1), the first coil group (6) extends radially outward at two winding heads (8).

11. The stator according to claim 10, wherein the first coil group (6) is shaped at the two winding heads (8) such that the first coil group (6) extends parallel to axial end faces (9) of the stator core (1).

12. The stator according to claim 9, wherein the second coil group (7) is shaped such that when the second coil group (7) is fitted in the grooves (2) of the stator core (1), the second coil group (7) extends radially inward at a first winding head (10).

13. The stator according to claim 12, wherein the second coil group (7) is shaped at the first winding head (10) such that the second coil group (7) extends parallel to a rotor bar (11) of a rotor (12).

14. The stator according to claim 9, wherein the first coil group (6) and the second coil group (7) each comprise between one and seven coils (14), and only one coil (14) of one of the first coil group (6) and only one coil (14) of the second coil group (7) is arranged in each of the grooves (2) of the stator core (1).

15. The stator according to claim 9, wherein the grooves (2) of the stator core (1) have parallel sides (17).

16. The stator according to claim 9, wherein each of the first coil group (6) and the second coil group (7) has two coils (14, 22).
